(19) United States
(12) Patent Application Publication
(10) Pub. No.: US 2016/0063385 A1
(43) Pub. Date: Mar. 3, 2016

(54) TIME SERIES FORECASTING USING SPECTRAL TECHNIQUE

(71) Applicant: InMobi PTE LTD., Singapore (SG)

(72) Inventors: Rajesh Kumar Singh, Bangalore (IN); Deepak Kumar Barr, New Delhi (IN); Sumit Bharti, Haryana (IN); Sunil Kalva, Bangalore (IN)

(73) Assignee: InMobi PTE LTD., Singapore (SG)

(21) Appl. No.: 14/837,618

(22) Filed: Aug. 27, 2015

(30) Foreign Application Priority Data
Aug. 27, 2014 (IN) 4192/CHE/2014

(51) Int. Cl. G06N 5/04; G06F 17/14

(52) U.S. Cl. CPC G06N 5/04; G06F 17/142

(57) ABSTRACT

A system and method provide spectral forecasting using a time series data set, wherein the time series data set includes one or more seasonality patterns, the system comprising a data collection module, wherein the data collection module is configured to record one or more recordings. Further, the system includes a filter, wherein the filter is configured to clean the one or more recordings made by the data collection module. Furthermore, the system includes a time series historian configured to store the cleaned one or more recordings as a time series data set. In addition, the system includes a determination module, the determination module comprising one or more processors and a non-transitory memory containing instructions that, when executed by said one or more processors, cause said one or more processors to perform a set of steps.

### FIELD OF INVENTION

The present invention relates to time series data. In particular, the invention relates to spectral forecasting using time series data.

### BACKGROUND

Forecasting is a very important activity in economics, commerce, and various branches of science. Forecasting is the process of estimating the outcomes of events that have not yet occurred. Forecasting can be done by various methods. One such methods of forecasting is time series forecasting. Time series forecasting is a statistical method in which historical data or time series data is analyzed to predict the possible data values in the future horizon. Time series forecasting further contains various methods of forecasting the time series data such as, moving average technique, weighted moving average techniques, exponential smoothing techniques and the like. Weighted moving average techniques are not suitably equipped to handle the presence of trend and seasonality patterns in the time series, and thereby not efficient to forecast.

Furthermore, time-series forecasting can be generated by another set of methods known as exponential smoothening methods. One such method is triple exponential smoothing (herein after referred to as TES). The TES method can be used for forecasting time-series having trend and seasonal pattern. However, the disadvantage of using this method is that, TES cannot handle if there are plurality of seasonality in the time series.

One of the well-known methods of time series forecasting is the autoregressive integrated moving average technique (ARIMA). It combines auto regression, which fits the current data point to a linear function of prior data points, and moving averages, adding together several consecutive data points and getting their mean, and then using that to compute estimations of the next value. However, ARIMA is not embedded within any underlying theoretical model or structural relationships. The economic significance of the chosen model is therefore not clear. Furthermore, it is not possible to run policy simulations with ARIMA models, unlike with structural models. In addition, ARIMA does not handle the presence of multiple seasonalities.

In light of the above discussion, there is a need for a method and system for spectral forecasting using time series data.

### SUMMARY

In at least one embodiment, a system and method performs spectral forecasting by using a time series data set, wherein the time series data set includes one or more seasonality patterns, the system comprising a data collection module, wherein the data collection module is configured to record one or more recordings. Further, the system includes a filter, wherein the filter is configured to clean one or more recordings made by the data collection module. Furthermore, the system includes a time series historian configured to store the cleaned one or more recordings as a time series data set. In addition, the system includes a determination module, the determination module comprising one or more processors and a non-transitory memory containing instructions that, when executed by said one or more processors, cause said one or more processors to perform a set of steps.

In an embodiment, the steps performed by the one or more processors include subtracting a mean of the time series data set from each element of the time series data set for making the time series data set mean centric. In addition, the steps include detrending the mean centric time series data set by using a first order differencing technique. Further, the steps include obtaining the power spectrum of the mean centric time series data set. Furthermore, the steps include selecting a set of frequencies from the power spectrum of the mean centric time series data set, wherein the selecting of the set of frequencies is done based on energy of the frequencies, the energy being the highest in the power spectrum. Further, the steps include reconstructing the time series data set from selected set of frequencies. Moreover, the steps include determining the cycle of optimal periodicity from the reconstructed time series data set

In an embodiment, the one or more processors obtain the power spectrum by applying fast Fourier transform on the mean centric time series data. In another embodiment, the one or more processors obtain the cycle of optimal periodicity by applying autocorrelation technique. In this embodiment, the one or more processors obtain a time domain representation of the cycle of optimum periodicity. In this embodiment, the one or more processors obtain the time domain representation (herein after referred to as reconstructed time series data set) of the selected set of frequencies by applying inverse fast Fourier transform.

In another embodiment, the one or more processors obtain a set of future points using the reconstructed time series data set and the cycle of optimal periodicity. In this embodiment, the one or more processors obtain the set of future points by replicating the cycle of optimal periodicity present in the reconstructed time series data set in the future horizon. In this embodiment, the one or more processors perform reverse differencing to bring back the trend factor into the obtained set of future points. In this embodiment, the one or more processors add the mean of the time series data to each element of the set of future points to obtain the final forecast values.

In another aspect, a method determines a cycle of optimal periodicity in a time series data set. The method includes subtracting the mean of the time series data set from each element of the time series data set for making the time series data set mean centric. Further the method includes performing first order differencing on the mean centric time series data set for detrending the mean centric time series data set. Furthermore, the method includes obtaining the power spectrum of the mean centric time series data set. In addition, the method includes selecting a set of frequencies from the power spectrum of the mean centric time series data set, wherein the selecting of the set of frequencies is done based on energy of the frequencies, the energy being the highest in the power spectrum. Further, the steps include reconstructing the time series data set from the selected set of frequencies. Moreover, the method includes determining the cycle of optimal periodicity present in the reconstructed time series data set.

In an embodiment, the method includes obtaining reconstructed time series data set from the selected set of frequencies by applying inverse fast Fourier transform. In another embodiment, the method includes obtaining the power spectrum of the time series data by applying fast Fourier transform. In another embodiment, the method includes obtaining the cycle of optimal periodicity by using autocorrelation technique.

In yet another embodiment, the method includes, forecasting a set of future points based on the determined optimal periodicity, wherein the forecasting is performed by replicating the determined optimal periodicity present in the reconstructed time series data set in the future horizon. In this embodiment, the method includes performing reverse differencing on the set of future points. In this embodiment, the method includes adding the mean of the historical time series data set to the set of future points for obtaining a set of the final forecast values.

### BRIEF DESCRIPTION OF THE DRAWINGS

FIG. 1 illustrates a system for spectral forecasting using a time series data set.

FIG. 2 illustrates a block diagram of a determination module.

FIG. 3 illustrates a flowchart for determining a cycle of optimal periodicity in a time series data.

FIGS. 4A and 4B illustrate a flowchart for determining a set of forecast points. FIGS. 4A and 4B are collectively referred to as “FIG. 4”.

### DETAILED DESCRIPTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

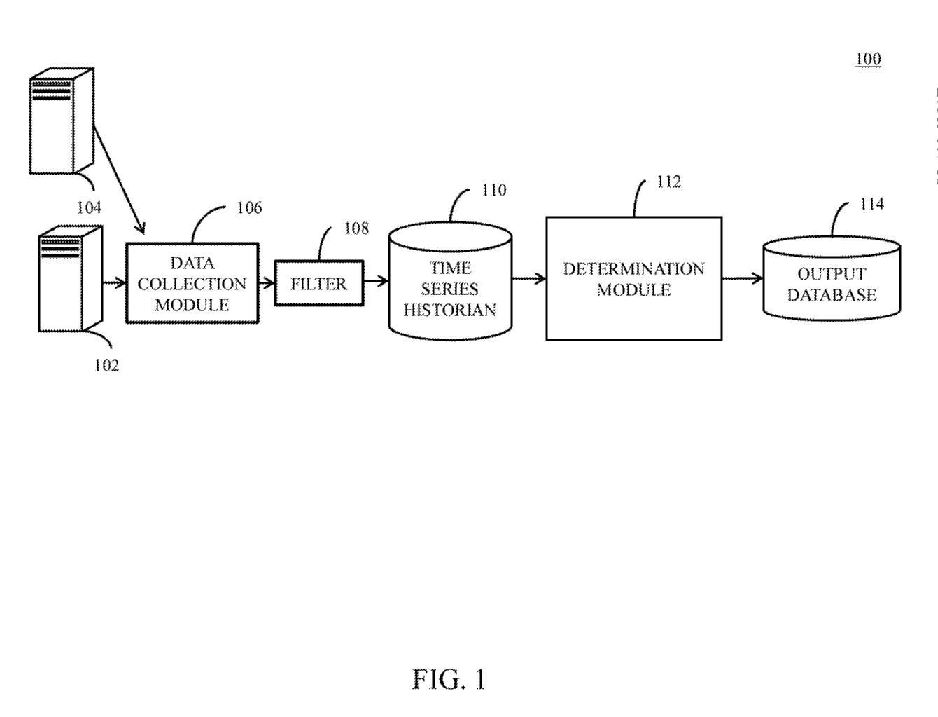

FIG. 1 illustrates a system 100 for spectral forecasting using a time series data set. The system 100 includes an application server 102 and an application server 104. The application server 102 and the application server 104 perform various operations. The application server 102 and the application server 104 maintain logs relating to the operations performed.

In an embodiment, the application server 102 and the application server 104 are advertisement servers, which maintain the record of the advertisements requests received from mobile websites and applications. In another embodiment, the application server 102 and the application server 104 are market analysis sewers, which maintain a record of the closing stock values of a plurality of companies. In yet another embodiment, the application server 102 and the application server 104 are tourism management servers, which maintain a record of the frequency of visits by tourists to a tourist destination.

Examples of logs maintained by the application server 102 and the application server 104 include but may not be limited to daily closing values the stocks of a plurality of companies, the number of advertisements requests received from plurality of mobile websites and applications on a daily basis and the like. A data collection module 106 interacts with the application server 102 and the application server 104 to collect the data. The data collection module 106 collects the required type of data from various types of data stored in the application server 102 and the application server 104. The data collected by the data collection module 106 is further filtered by a filter 108.

The filter 108 sorts and removes data entries according to a predetermined requirement. In an embodiment, the data collection module 106 collects the data regarding advertisement request received in a particular time span. The filter 108 cleans the data collected by the data collection module 106 by caching advertisement request received on specified date according to a given condition.

A time series historian 110, coupled to the aggregator 108, stores the cached data. The time-series historian 110 is a database that stores history of time-based process data. In an embodiment, the time series historian 110 is a database that stores advertisement requests received from a plurality of mobile websites and applications, before a predetermined time on a predetermined date.

The time series historian 110 is coupled to a determination module 112. A time series data set has three components, namely, level, trend and seasonality. In order to analyze the various seasonality patterns in the time series data set, the level and trend components must be removed from the time series data set. The determination module 112 is configured to determine a cycle of optimal periodicity by removing the level and trend factor from the data obtained from the time series historian 110. The determination module 112 obtains a power spectrum of the time series data and removes the frequencies having low energy against a pre-determined threshold. The determination module 112 reconstructs the time series data set using the retained set of frequencies to obtain the reconstructed time series data set. The determination module 112 determines the cycle of optimal periodicity present in the reconstructed time series data set. In an embodiment, the determination module 112 uses autocorrelation technique to determine the cycle of optimal periodicity present in the reconstructed time series data set. In an embodiment, the determination module 112 is configured to use the cycle of optimal periodicity and the reconstructed time series data set to obtain a set of forecast values and store the forecast values in an output database 114.

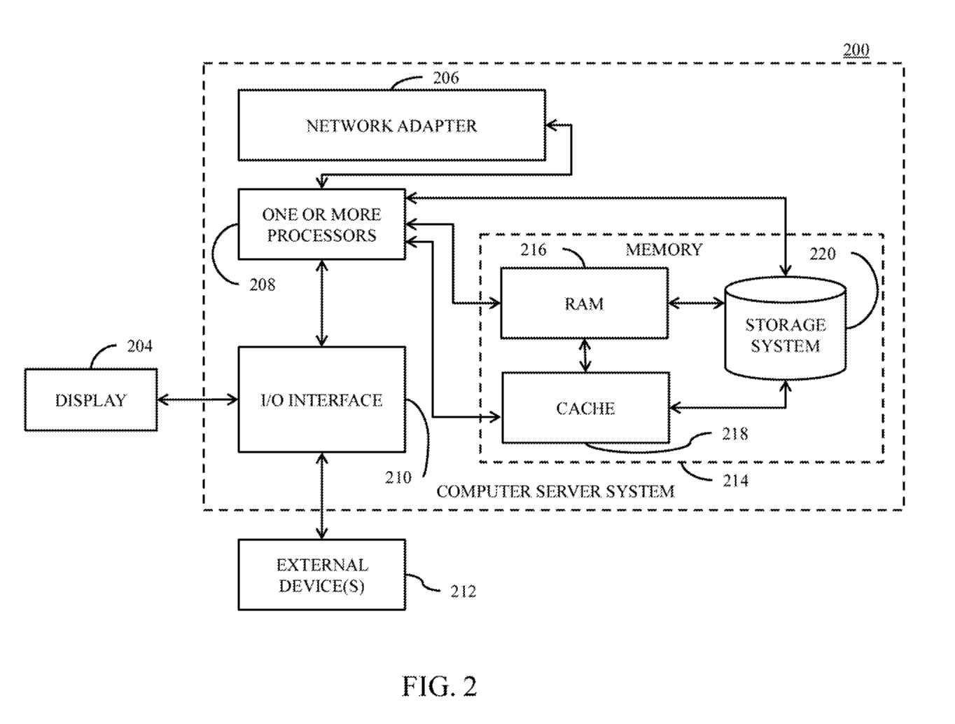

FIG. 2 illustrates a block diagram of a determination module 200. The components of the determination module 200 include but are not limited to one or more processors 208, a system memory 214, a network adapter 206, an input-output (I/O) interface 210 and one or more buses that couple various system components to the one or more processors 208.

The one or more bus represents one or more of any of several types of bus structures, including a memory bus or memory controller, a peripheral bus, an accelerated graphics port, and a processor or local bus using any of a variety of bus architectures. By way of example, and not limitation, such architectures include industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The determination module 200 typically includes a variety of computer system readable media. Such media is any available media that is accessible by the determination module 200, and includes both volatile and nonvolatile media, removable and non-removable media. In an embodiment, the system memory 214 includes computer system readable media in the form of volatile memory, such as random access memory (RAM) 216 and cache memory 218. The determination module 200 further includes other removable/non-removable, nonvolatile computer system storage media. In an embodiment, the system memory 214 includes a storage system 220.

The determination module 200 can communicate with one or more external devices 212 and a display 204, via input-output (I/O) interfaces 210. In addition, the determination module 200 can communicate with one or more networks such as a local area network (LAN), a general wide area network (WAN), and/or a public network (for example, the Internet) via the network adapter 206.

It can be understood by one skilled in the art that although not shown other hardware and/or software components can be used in conjunction with the determination module 200. Examples, include, but are not limited to microcode, device drivers, redundant processing units, external disk drive arrays, RAID systems, tape drives, and data archival storage systems, and the like.

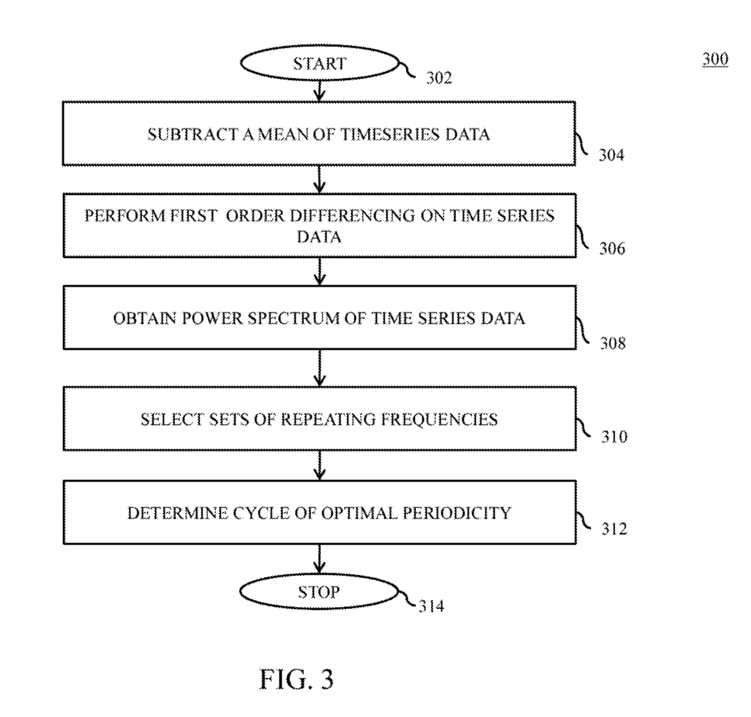

FIG. 3 illustrates a flowchart 300 for determining a cycle of optimal periodicity in the time series data set. At step 302, the flowchart 300 initiates. At step 304, the determination module 112 subtracts the mean of the time series data set from each element of the time series data set. The determination module 112 subtracts the mean in order to remove the level component from the time series data set and make the time series data set mean centric.

At step 306, the determination module 112 performs detrending on the obtained mean centric time series data set. The presence of trend component in the time series data set causes the mean centric time series data set to evolve in an increasing or decreasing fashion. In an embodiment, the determination module 112 performs first order differencing on the obtained mean centric time series data set in order to remove the trend component from the mean centric time series data set.

At step 308, the determination module 112 obtains a power spectrum of the de-trended mean centric time series data. In an embodiment, the determination module 112 obtains the power spectrum of the de-trended mean centric time series data set by applying Fast Fourier transform on the de-trended mean centric time series data set. The power spectrum of the time series data set is a representation of the distribution of energy with respect to various frequencies.

At step 310, the determination module 112 retains a set of frequencies, which have the highest energy in the power spectrum and discards other frequencies. The determination module 112 applies inverse fast Fourier transform on the retained frequencies in order to obtain a reconstructed time series data set corresponding to the retained frequencies. At step 312, the determination module 112 determines a cycle of optimal periodicity. In an embodiment, the determination module 112 uses autocorrelation technique in order to determines a cycle of optimal periodicity. Autocorrelation is a measure of similarity of a data set with itself. The performance of autocorrelation on the reconstructed time series data set determines a cycle in the reconstructed time series dataset, which is the longest periodic cycle. The determined cycle is the cycle of optimal periodicity. The flowchart 300 terminates at step 314.

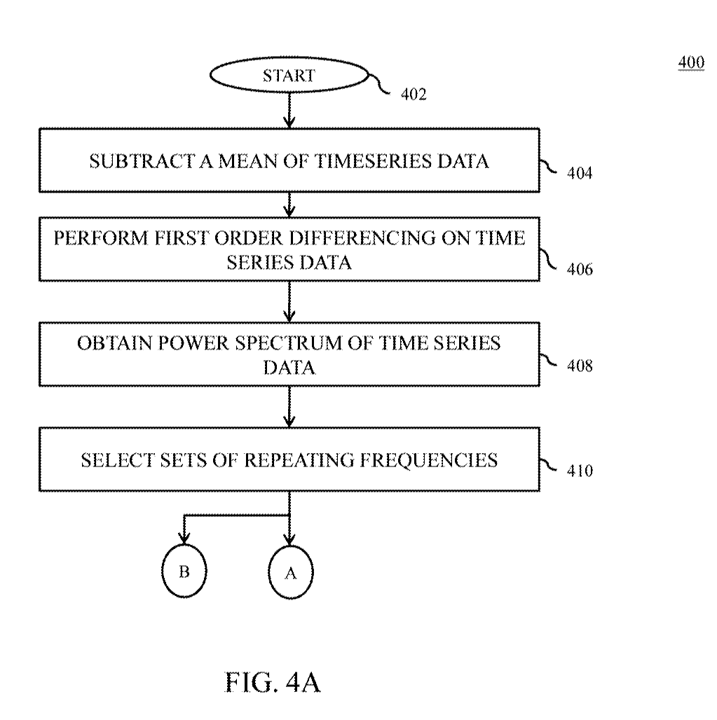

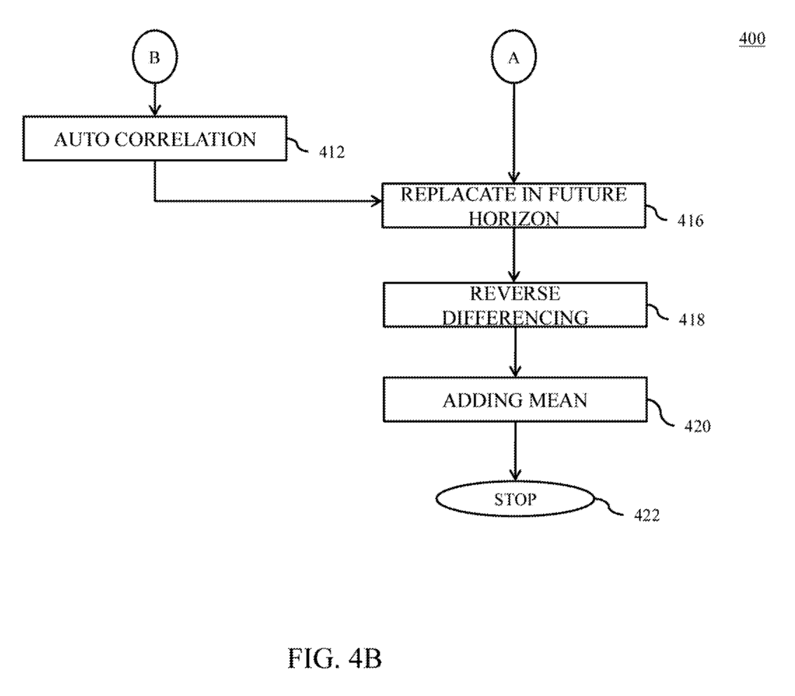

FIG. 4 illustrates a flowchart 400 for determining a set of forecasted points. The flowchart 400 initiates at step 402. At step 404, the determination module 112 subtracts the mean of the time series data set from each element of the time series data set in order to obtain a mean centric time series data set. At step 406, the determination module 112 performs first order differencing for detrending the mean centric time series data set in order to remove the trend component in the mean centric time series data set. At step 408, the determination module 112 Obtains a power spectrum of the de-trended mean centric time series data set. At step 410, the determination module 112 retains a set of frequencies, which have the highest energy in the power spectrum and discards other frequencies. The determination module 112 applies inverse fast Fourier transform on the retained frequencies in order to obtain the reconstructed time series data set corresponding to the retained frequencies. At step 412, the determination module 112 uses an autocorrelation technique to determine a cycle of optimal periodicity.

At step 414, the determination module 112 replicates the cycle of optimal periodicity present in the reconstructed time series data set in the future horizon in order to obtain a set of future points. At step 416, the determination module 112 performs reverse differencing on the obtained set of future points. The determination module 112 performs reverse differencing on the obtained set of future points in order to bring back the trend component into the future points. At step 418, the determination module 112 adds the mean of the time series data set to each element of the set of future points to obtain the final set of forecast points. The determination module 112 performs addition of the mean of the time series data set to each element of the set of future points in order to bring back the level component in the forecasted time series data set. The flowchart terminates at step 420.

In at least one embodiment, the system and method identify the optimal seasonality from multiple seasonalities present in the time series data set. By doing so, the system and method ascertain the data points over which forecasting can be performed, thereby increasing the accuracy of the forecast.

This written description uses examples to describe the subject matter herein, including the best mode, and to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for spectral forecasting using a time series data set, wherein the time series data set includes one or more seasonality patterns, the system comprising:
a data collection module, wherein the data collection module is configured to record one or more recordings;
a filter, wherein the filter is configured to clean the one or more recordings made by the data collection module;
a time series historian configured to store the cleaned one or more recordings as a time series data set; and
a determination module, wherein the determination module comprises:
one or more processors; and
a non-transitory memory containing instructions that, when executed by said one or more processors, cause said one or more processors to perform a set of steps comprising:
subtracting the mean of the time series data set from each element of the time series data set for making the time series data set mean centric;
detrending the mean centric time series data set;
obtaining a power spectrum of the de-trended mean centric time series data set;
selecting a set of frequencies from the power spectrum of the mean centric time series data set, wherein the selecting of the set of frequencies is done based on energy of the frequencies, the energy being the highest in the power spectrum;
reconstructing the time series data set from selected set of frequencies; and
determining the cycle of optimal periodicity from the reconstructed time series.

2. The system as claimed in claim 1, wherein the one or more processors are further configured to reconstruct the time series data set from the selected set of frequencies by applying inverse fast Fourier transform on the selected set of frequencies.

3. The system as claimed in claim 1, wherein the one or more processors obtain the power spectrum of the mean centric time series data sets by applying fast Fourier transform on the mean centric time series data set.

4. The system as claimed in claim 1, wherein the one or more processors determine the cycle of optimal periodicity using autocorrelation technique.

5. The system as claimed in claim 1, wherein the one or more processors are further configured to forecast a set of future points based on the determined optimal periodicity and reconstructed time series data set, wherein the forecasting is performed by replicating the determined optimal periodicity present in the reconstructed time series data set in the future horizon for obtaining a set of future points.

6. The system as claimed in claim 5, wherein the one or more processors are further configured to perform reverse differencing on the set of future points.

7. The system as claimed in claim 6, wherein the one or more processors are further configured to add the mean of the time series data set to the set of future points for obtaining the forecasted time series data set.

8. A method for spectral forecasting using a time series data set, wherein the time series data set includes one or more seasonality patterns, the method comprising:
subtracting a mean of the time series data set from each element of the time series data set for making the time series data set mean centric;
performing first order differencing on the mean centric time series data set for detrending the mean centric time series data set;
obtaining the power spectrum of the de-trended mean centric time series data set;
selecting a set of frequencies from the power spectrum of the mean centric time series data set, wherein the selecting of the set of frequencies is done based on energy of the frequencies, the energy being the highest in the power spectrum; and
determining the cycle of optimal periodicity from the selected set of frequencies.

9. The method as claimed in claim 8, further comprising reconstructing the time series data set from the selected set of frequencies by applying inverse fast Fourier transform on the selected set of frequencies.

10. The method as claimed in claim 8, further comprising forecasting a set of future points based on the determined optimal periodicity and the reconstructed time series data set, wherein the forecasting is performed by replicating the determined optimal periodicity present in the reconstructed time series data set in the future horizon for obtaining a set of future points.

11. The method as claimed in claim 10 further comprising, performing reverse differencing on the set of future points.

12. The method as claimed in claim 10 further comprising, adding the mean of the time series data set to the set of future points for obtaining the forecasted time series data set.
